(19) United States
(12) Patent Application Publication
(10) Pub. No.: US 2004/0047467 A1
(43) Pub. Date: Mar. 11, 2004

(54) Document encoding by pixel block transformation and document decoding by overlaying

(76) Inventors: John M. Hall, Moscow, ID (US); David Ritzenthaler, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/237,513

(22) Filed: Sep. 9, 2002

(51) Int. Cl. H04K 1/06

(52) U.S. Cl. 380/37

(57) ABSTRACT

A method is disclosed that generates a first plurality of blocks of pixels corresponding to pixels of a document. A second plurality of blocks of pixels is generated by transforming the first plurality of blocks of pixels, based on values of the pixels of the document to which first plurality of blocks of pixels correspond.

### BACKGROUND

Document generation has become a mainstay use of computers. The term document as used herein is inclusive of any type of data file that can be created using a computer, including text-oriented documents, image- and graphic-oriented documents, as well as other types of documents. Once a document is generated using a computer, it may be delivered electronically, as a data file, or it may be delivered as a hardcopy, printed on a sheet of media such as paper.

Security can become an issue with the delivery of computer-generated documents. Printing a document within an organizational environment may entail outputting the document at a shared printer within a public area. Others may thus review a sensitive document before the individual who generated the document can retrieve it from the printer. Hardcopy documents delivered within inter-office mail, or even by postal mail, are also vulnerable to interception and review by unauthorized personnel.

Electronic documents, as data files, are perhaps no less sensitive to such interception. Unless encrypted email is specifically used, unscrupulous hackers may potentially be able to intercept the email intended for another. While email encryption is available, it is not widely used, and even confidential and sensitive documents are frequently exchanged over unencrypted email.

### SUMMARY

The invention can be embodied within a method that generates a first plurality of blocks of pixels corresponding to pixels of a document. A second plurality of blocks of pixels is generated by transforming the first plurality of blocks of pixels, based on values of the pixels of the document to which first plurality of blocks of pixels correspond.

### BRIEF DESCRIPTION OF THE DRAWINGS

The drawings referenced herein form a part of the specification. Features shown in the drawings are meant as illustrative of only some embodiments of the invention, and not of all embodiments of the invention, unless otherwise explicitly indicated, and implications to the contrary are otherwise not to be made.

FIGS. 1A and 1B are a flowchart of a method and a diagram illustrating an example performance of the method, respectively, according to an embodiment of the invention.

FIGS. 2A and 2B are diagrams of two different types of pixel blocks from which a first section of pixel blocks is randomly assembled as an encoding and decoding section, according to an embodiment of the invention.

FIGS. 3A and 3B are diagrams depicting the decoding process for the pixel blocks of FIGS. 2A and 2B, respectively, where a corresponding, first pixel block and a corresponding second pixel block are instances of the same block, according to an embodiment of the invention.

FIG. 4 is a diagram showing the decoding process for the pixel blocks of FIGS. 2A and 2B, where a corresponding first pixel block and a corresponding pixel block are instances of different blocks, according to an embodiment of the invention.

FIG. 5 is a diagram of a system according to an embodiment of the invention.

FIG. 6 is a diagram illustrating an example decoding process, according to an embodiment of the invention.

FIGS. 7A, 7B, 7C, and 7D are diagrams illustrating an actual example of the encoding and decoding process, using the pixel blocks of FIGS. 2A and 2B, and using the decoding process of FIGS. 3A, 3B, and 4, according to an embodiment of the invention.

### DETAILED DESCRIPTION OF THE PREFERRED EMBODIMENTS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

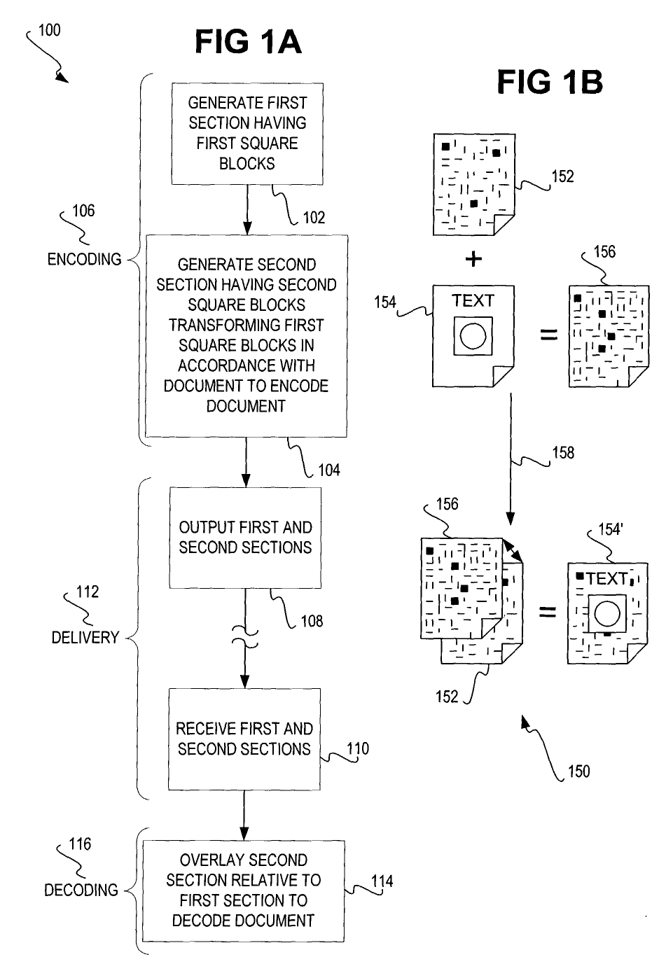

FIG. 1A shows a method 100, according to an embodiment of the invention, whereas FIG. 1B shows an example illustrative performance 150 of the method 100, according to an embodiment of the invention. The method 100 can be implemented in one embodiment of the invention as a computer program having instructions to perform the method 100. The computer program may be stored on a computer-readable medium, such as a removable or fixed storage, a volatile or non-volatile storage, and so on. The program may be executable by a computing device such as a computer, as well as by an image-forming device such as a printer. In the latter instance, the program may be stored as part of the firmware of the image-forming device.

A first section is generated that includes a number of first square blocks of pixels, to yield an encoding and decoding section (102). The first section may be a data file that can be output onto a media, such as a sheet of paper. The first square blocks of pixels are N×N pixel blocks, where N is greater than one. In FIG. 1B, the performance of 102 of FIG. 1A is depicted as the first section 152.

A second section is next generated that includes a number of second square blocks, which transform the first square blocks in accordance with a document to encode the document (104). The second section may be the same or a different data file as the first section, and can be output onto the same or a different piece of media, such as a sheet of paper, as the first section. The document has portions that correspond to the first square blocks of the first section. For example, each pixel of the document may correspond to a first square block of pixels of the first section. Each first block is transformed in accordance with its corresponding portion of the document to generate a second block of pixels. That is, each first block is transformed depending on its corresponding portion of the document to generate the second block. The second section of the second blocks of pixels thus encodes the document, utilizing the first section of the first blocks of pixels as an encoding section.

For instance, where the document is a collection of black and white pixels, each first block may be transformed in one manner if its corresponding document pixel is black, and may be transformed in another manner if its corresponding document pixel is white. For simplicity, the phrase white pixel is used, even where such a pixel may be, in fact, an absence of black. That is, a white pixel may be a pixel that is not a black pixel. Transformation as used herein includes performing no action at all, such that one of the transformations may be to copy the pixels of the first block verbatim to yield the pixels of the corresponding second block. As an example, the first blocks may be transformed in a particular manner where their corresponding document pixels are black, and may be copied to yield the second blocks where their corresponding document pixels are white. It can thus be said that the first section is selectively transformed in accordance with the document to yield the second section.

The second section can be decoded to yield the document only by using the first section that encoded the document, the first section thus also serving as the decoding section. In FIG. 1B, the performance of 104 of FIG. 1A is depicted by transforming the first section 152 relative to a document 154 to yield a section second 156. Furthermore, 102 and 104 of FIG. 1A may generally be referred to as the encoding process 106.

The first and second sections are output (108) so that they can be delivered and thus received (110). Output may be as the same or separate electronic data files, or as the same or separate pieces of media, such as sheets of paper. To ensure confidentiality and secure transmission and receipt, the sections may be sent separately, by different modes of transport, at different times, and so on. For instance, the first section may be sent by email, whereas the second section may be sent by floppy disk. As another example, the first and the second sections may be printed on separate sheets of paper, and sent in separate envelopes by mail, or at different times by facsimile. As a final example, for secure archival storage, the first and the second sections may be stored at different locations. 108 and 110 of FIG. 1A may generally be referred to as the delivery process 112, which is depicted in FIG. 1B as the arrow 158.

The second section is overlaid relative to the first section to decode and display the document (114). That is, the first and the second sections are overlaid relative to each other so that each second block of pixels is overlaid under or over its corresponding first block of pixels. Because the second section of second pixel blocks was generated by transforming the first section of first pixel blocks in accordance with the document, the document will be made visible, or decoded, by such overlaying. It is noted that the overlaying of the first and the second sections relative to one another is accomplished in an aligned manner. That is, the first pixel blocks of the first section are aligned over or under their corresponding second pixel blocks of the second section to yield the decoded document. If the first pixel blocks are not aligned relative to their corresponding second pixel blocks, the decoded document will not be visible.

In the example previously described where the second pixel blocks are copies of the first pixel blocks where their corresponding document pixels are white, and the second pixel blocks are transformations of the first pixel blocks where their corresponding document pixels are black, the document decoding process is as follows. When the first section of first blocks is overlaid relative to the second section of second blocks, white pixels of the document will be revealed as the corresponding first blocks and the corresponding second blocks being identical to one another, since the second blocks are copies of the first blocks in such instances. Conversely, black pixels of the document will be revealed as the corresponding first blocks and the corresponding second blocks being different from one another, since the second blocks are transformations of the first blocks in such instances.

Thus, the decoded document may be revealed as the document over the background of the first section. In FIG. 1B, the performance of 114 is depicted as the second section 156 and the first section 152 being overlaid relative to one another, to yield the decoded document 154′. The decoded document 154′ is indicated as different than the document 154 for the embodiment in which the decoded document is revealed as the document over the background of the first section 152. Finally, 114 of FIG. 1A may generally be referred to as the decoding process 116. The encoding process 106, the delivery process 112, and the decoding process 116 are all described in more detail as specific embodiments of the invention in subsequent sections of the detailed description.

Although the method 100 of the embodiment of FIG. 1A, and the performance 150 of which is exemplary depicted in the embodiment of FIG. 1B, have been substantially described in relation to pixels that are on and off, such as black and white, other types of pixels may also be used. For instance, each pixel may have one of a number of different values, corresponding to different levels of black and white, gray scale, halftone, color, and so on. [Steve—the inventors indicated that the invention is applicable to these various other scenarios, BUT that it would require a significant amount of additional work to “figure out” . . . That's why there isn't additional description regarding such alternative embodiments in the application. That said, I'd prefer to leave this sentence in to ensure broadness of claim interpretation.] That is, the method 100 has been described in substantial relation to black-and-white (i.e., two-value) pixels only for explanatory convenience and illustrative clarity, and not to convey a limitation of embodiments of the invention. Similarly, whereas the method 100 has been described in relation to pixel blocks that are square, in alternative embodiments of the invention, they may be more generally rectangular, or any other shape.

Encoding

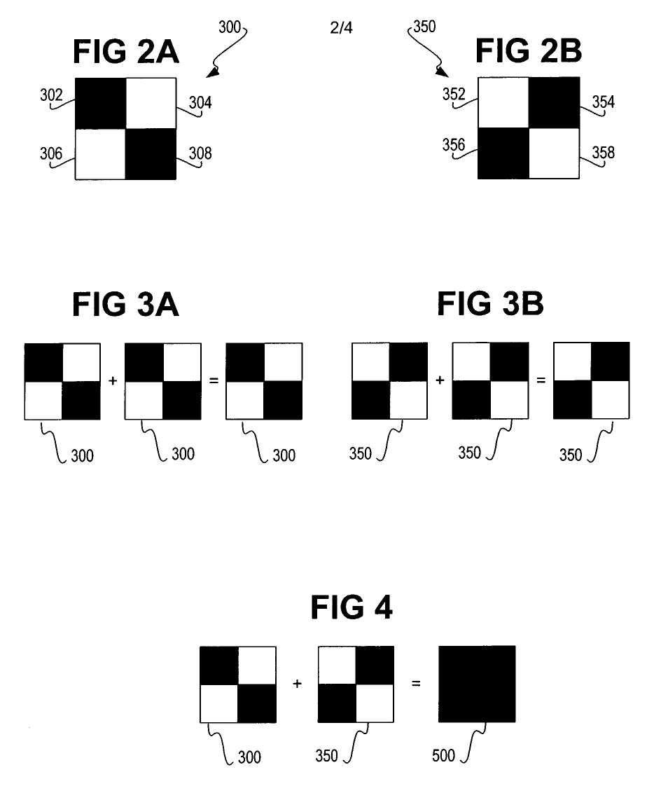

The encoding process 106 of the method 100 of FIG. 1A can be specifically accomplished in one embodiment of the invention as described in this section of the detailed description. The pixel blocks of the first section are two pixel-by-two pixel blocks, where each pixel is either black or white. More specifically, the pixel blocks of the first section are randomly selected in 102 of FIG. 1A as either the pixel block 300 of FIG. 2A, or the pixel block 350 of FIG. 2B. The pixel blocks 300 and 350 are the inverses of one another. Thus, the pixel block 300 has a black pixel 302, a white pixel 304, a white pixel 306, and a black pixel 308, corresponding to the pixel block 350, which has a white pixel 352, a black pixel 354, a black pixel 356, and a white pixel 358.

To generate the second pixel blocks of the second section in 104 of FIG. 1A, the first pixel blocks of the first section that have been generated are transformed in accordance with a document as follows. For each pixel of the document that is black, the second pixel block is determined as the inverse of the corresponding first pixel block. Thus, where a first pixel block is the block 300, the corresponding second pixel block is the block 350, and vice-versa. For each pixel of the document that is white, the second pixel block is determined by copying the corresponding first pixel block. Thus, where a first pixel block is the block 300, the corresponding second pixel block is also the block 300. Similarly, where a first pixel block is the block 350, the corresponding second pixel block is also the block 350.

The use of the pixel blocks 300 and 350 of FIGS. 2A and 2B, respectively, and the use of an inverse operation to generate the second pixel blocks of the second section only where the corresponding pixels of the document are black, provides for easily visible decoding by essentially performing an exclusive-or operation as is now described. For a white pixel of the document, both the corresponding first pixel block of the first section and the corresponding second pixel block of the second section are either instances of the pixel block 300 or the pixel block 350. For the former case, as shown in FIG. 3A, overlaying two instances of the pixel block 300 yields the same pixel block 300. Similarly, for the latter case, as shown in FIG. 3B, overlaying two instances of the pixel block 350 yields the same pixel block 350. That is, white pixels of the document are displayed in the decoded document as the pixel block 300 or the pixel block 350.

For a black pixel of the document, one of the corresponding first pixel block of the first section and the corresponding second pixel block of the second section is the pixel block 300, and the other of the corresponding first and second pixel blocks is the pixel block 350. As shown in FIG. 4, overlaying an instance of the pixel block 300 and an instance of the pixel block 350 yields a completely solid, or black, pixel block 500. Thus, black pixels of the document are displayed in the decoded document as the pixel block 500. This means that the resulting decoded document will be made visible as a number of the pixel blocks 500 against a background of a random assortment of the pixel blocks 300 and 350.

Delivery

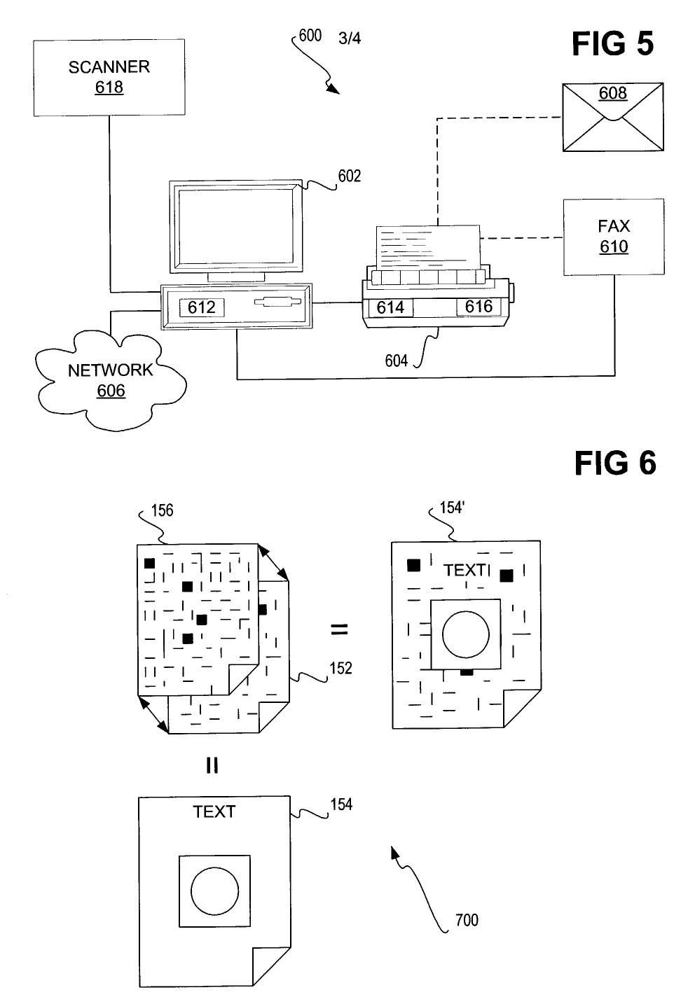

The delivery process 112 of the method 100 of FIG. 1A can be specifically accomplished in one embodiment of the invention as described in this section of the detailed description. FIG. 5 shows a system 600 according to an embodiment of the invention. The system 600 includes a computing device 602, such as a computer, and one or more of the following optional components: an image-forming device 604, such as a printer, a network 606, such as the Internet, a postal mail delivery mechanism 608, such as a mailbox, a fax machine 610, and a scanner 618. A number of these optional components may be combined as a single component. For instance, the image-forming device 604, the fax machine 610, and/or the scanner 618 may be combined as a single multi-function device (MFD).

Where the system 600 is for generating and sending first and second sections as have been described, the computer 602 may include a computer-readable medium 612 programmed to cause the computer to generate the first and second sections. The computing device 602 may then send the first and second sections as data files attached to email through the network 606, or may directly control the fax machine 610, which may be a faxmodem or other fax device internal to or external from the computing device 602, to send the first and second sections as facsimiles. The computer 602 may also output the first and second sections onto the same sheet or separate sheets of media, such as paper, transparencies, and so on, using the printer 604. Such hardcopy may then be sent through the postal mail delivery mechanism 608, or faxed using the fax machine 610. Inter-office mail, hand delivery, and so on, may also be used.

In another embodiment of the invention, the printer 604, which includes a controller 614, such as firmware, and an image-forming mechanism 616, may generate and output the first and second sections itself, based on a document received from the computing device 602. The controller 614 specifically generates the first and second sections, and causes the image-forming mechanism 616 to output the generated sections. The image-forming mechanism 616 may be a laser mechanism, an inkjet mechanism, and so on. The resulting hardcopy can then be sent through the postal mail delivery mechanism 608, or faxed using the fax machine 610. Inter-office mail, hand delivery, and so on, may also be used.

Where the system 600 is for receiving the first and second sections and decoding the document therefrom as have been described, the computer-readable medium 612 of the computing device 602 may cause the computing device 602 to decode the document from the first and second sections that have been received. The first and second sections may be received as data files attached to email received through the network 606, or as data files received through the fax machine 610, and decoded. The first and second sections may also be received as hardcopy, through the postal mail delivery mechanism 608, the fax machine 610, inter-office mail, hand delivery, and so on. The hardcopy may then be scanned in using the scanner 618, resulting in scanned-in image data files of the first and second sections which are decoded. Alternatively, the user may simply overlay the first section relative to the second section to manually decode the document therefrom.

Decoding

The decoding process 116 of the method 100 of FIG. 1A can be specifically accomplished in one embodiment of the invention as described in this section of the detailed description. FIG. 6 illustrates the performance 700 of the decoding process 116, according to an embodiment of the invention. The performance 700 is depicted in two different ways in FIG. 6. First, the second section 156 is overlaid relative to the first section 152, to yield the decoded document 154′, which is the document 154 against a background of the first section 152. Such decoding may be accomplished manually, with the user him or herself aligning the hardcopy of the two sections 152 and 156 over each other, or by a computing device, such as the device 602 of FIG. 5. In the latter instance, the computing device displays the first section 152 over or under the second section 156.

Second, the performance 700 is depicted in FIG. 6 as the second section 156 being overlaid relative to the first section 152 to yield the original document 154. That is, the original document 154 is not displayed against a background of the first section 152 as the decoded document 154′, as before, but is displayed without such a background. This may be accomplished by a computing device, such as the device 602 of FIG. 5, comparing corresponding first blocks with corresponding second blocks. If a first block corresponds to a second block in the manner by which the first block is transformed when an off, or white, pixel of the document is encountered, then such a white pixel is displayed. Similarly, if a first block corresponds to a second block in the manner by which the first block is transformed when an on, or black, pixel of the document is encountered, then such a black pixel is displayed.

For example, the transformation of a first block of the first section to a second block of the second section may be the copying of the first block when a white pixel of the document is encountered, and the inverse of the pixels of the first block when a black pixel is encountered. Therefore, if a comparison of a first block of the first section to a corresponding second block of the second section indicates that the blocks are identical, then a white pixel is displayed. Conversely, if a comparison of the first block to the corresponding second block indicates that the blocks are inversely related, then a black pixel is displayed. In this way, the original document can be decoded from the first and the second sections. It is noted that decoding and display of the original document in this manner is encompassed under the phrase of displaying the first section over or under the second section to decode the document.

### EXAMPLE

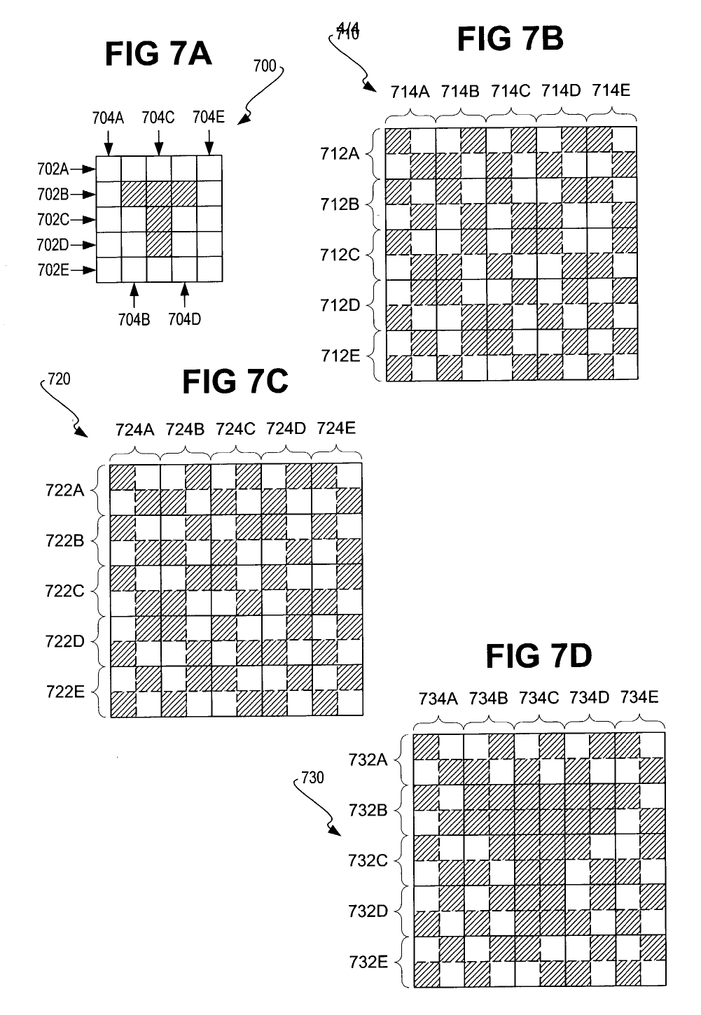

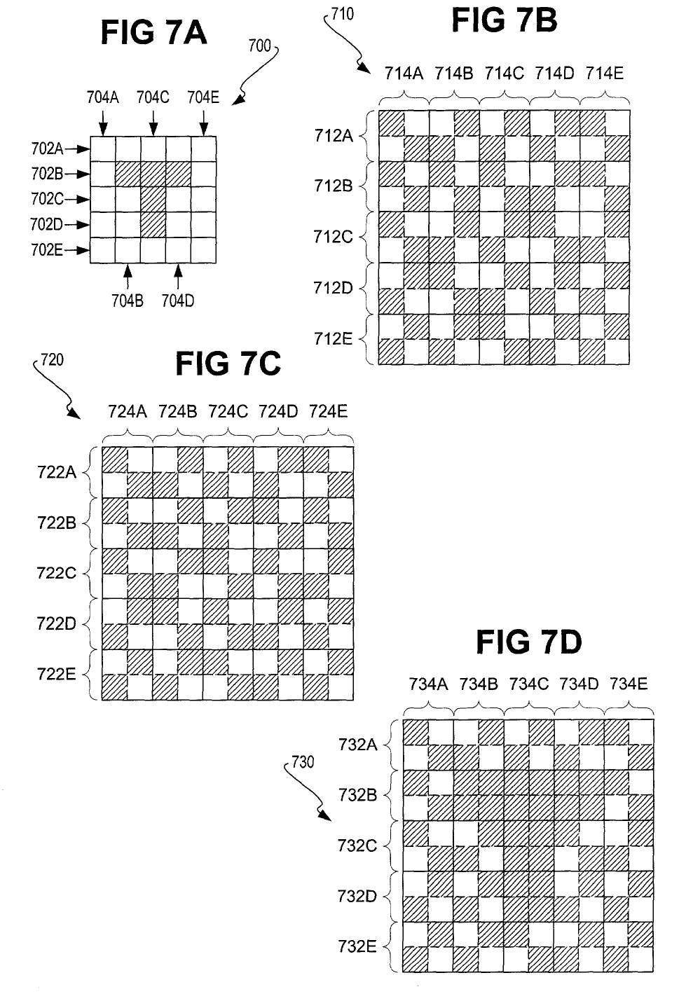

An actual example of the process by which a document can be encoded, and subsequently decoded, is described with reference to FIGS. 7A, 7B, 7C, and 7D. The example depicted in these figures utilizes the pixel blocks of FIGS. 2A and 2B, and the decoding process of FIGS. 3A, 3B, and 4. As can be appreciated by those of ordinary skill within the art, the example described in this section of the detailed description is for illustrative purposes only, and does not represent a limitation on the invention.

FIG. 7A shows a document 700 that is to be encoded. The document 700 has pixels organized along rows 702A, 702B, 702C, 702D, and 702E, and columns 704A, 704B, 704C, 704D, and 704E. For sake of description, a pixel of the document 700 is referenced as (x, y), where x is the reference number of the column in which the pixel lies, and y is the reference number of the row in which the pixel lies. Thus, the upper left-hand pixel of the document 700 is referenced as (704A, 702A), and the lower right-hand pixel of the document 700 is referenced as (704E, 702E). Black pixels are depicted in FIG. 7A as being shaded, for illustrative clarity. Lines separate adjacent pixels, even where both such pixels are white, also for illustrative clarity. Therefore, all the pixels of the document 700 are white, except for the following, which are black: (704B, 702B), (704C, 702B), (704D, 702B), (704C, 702C), (704C, 702D). These black pixels form a capital letter T.

FIG. 7B shows a first section 710 that is made up of a random collection of the pixel blocks 300 and 350 of FIGS. 2A and 2B, respectively. The first section 710 has pixel blocks organized along rows 712A, 712B, 712C, 712D, and 712E, and columns 714A, 714B, 714C, 714D, and 714E. Each pixel block is two pixels wide by two pixels high, and is either the pixel block 300 of FIG. 2A, or the pixel block 350 of FIG. 2B. That is, each pixel block (j, k) of the first section 710, where j is the reference number of the column in which the pixel block lies, and k is the reference number of the row in which the pixel block lies, is randomly selected as either the pixel block 300 of FIG. 2A, or the pixel block 350 of FIG. 2B. For example, the pixel block (714A, 712A) has been randomly selected as the pixel block 300 of FIG. 2A, whereas the pixel block (714B, 712A) has been randomly selected as the pixel block 350 of FIG. 2B. In FIG. 7B, pixel blocks are demarcated from one another with solid lines, and pixels within the pixel blocks are demarcated from one another with dotted lines.

Furthermore, the pixel blocks of the first section 710 correspond in number and position to the pixels of the document 700. There are thus five rows and five columns of pixel blocks in the first section 710, since there are five rows and five columns of pixels in the document 700. For example, the pixel block (714A, 712A) of the first section 710 corresponds to the like-positioned pixel (704A, 702A) of the document 700, the pixel block (714B, 712A) corresponds to the like-positioned pixel (704B, 702A), and so on.

FIG. 7C shows a second section 720, which is generated by selectively inversing pixel blocks of the first section 710, based on whether the corresponding pixel of the document 700 is black or white. More specifically, where a pixel of the document 700 is white, then the corresponding pixel block of the first section 710 is copied verbatim to the second section 720. Where a pixel of the document 700 is black, then the inverse of the corresponding pixel block of the first section 710 is copied to the second section 720. Thus, the second section 720 has pixel blocks organized along rows 722A, 722B, 722C, 722D, and 722E, and columns 724A, 724B, 724C, 724D, and 724E. Each pixel block of the second section 720 can be referenced as (m, n), where m is the reference number of the column in which the pixel block lies, and n is the reference number of the row in which the pixel block lies.

As an example of how some of the pixel blocks of the second section 720 are generated, the pixel block (724A, 722A) is identical to the corresponding pixel block (714A, 712A) of the first section 710. This is because the corresponding pixel (704A, 702A) of the document 700 is white, so the pixel block (714A, 712A) of the first section 710 is copied verbatim as the pixel block (724A, 722A) of the second section 720. That is, both the pixel block (714A, 712A) of the first section 710 and the pixel block (724A, 722A) of the second section 720 are the pixel block 300 of FIG. 2A. The pixel block (714A, 712A) of the first section 710 was randomly selected as the pixel block 300 of FIG. 2A. Then, because the pixel (704A, 702A) of the document 700 is white, the pixel block (724A, 722A) of the second section 720 is generated as a verbatim copy of the pixel block (714A, 712A) of the first section 710.

As another example, the pixel block (724C, 722C) of the second section 720 is the inverse of the corresponding pixel block (714C, 712C) of the first section 710. The term inverse in this situation means that the pixels of the pixel block (714C, 712C) of the first section 710 are switched from black to white or white to black to yield the pixels of the pixel block (724C, 722C) of the second section 720. That is, whereas the pixel block (714C, 712C) of the first section 710 is the pixel block 350 of FIG. 2B, the pixel block (724C, 722C) of the second section 720 is the pixel block 300 of FIG. 2A. The pixel block (724C, 722C) of the second section 720 is the inverse of the pixel block (714C, 712C) of the first section 710 because the corresponding pixel (704C, 702C) of the document 700 is black.

Thus, the pixel block (714C, 712C) of the first section 710 was randomly selected as the pixel block 350 of FIG. 2B. Because the pixel (704C, 702C) of the document 700 is black, the pixel block (724C, 722C) of the second section 720 is generated as the inverse of the pixel block (714C, 712C) of the first section 710. That is, the pixel block (724C, 722C) of the second section is generated as the pixel block 300 of FIG. 2A, which is the inverse of the pixel block 350 of FIG. 2B.

In FIG. 7D, the decoded document 730 is generated by overlaying the first section 710 over or under the second section 720. This means that the pixel blocks of the first section 710 are overlaid over or under their corresponding pixel blocks of the second section 720, and thus that the pixels of each pixel block of the first section 710 are overlaid over or under their corresponding pixels of the corresponding pixel block of the second section 720. The pixels of the resulting pixel blocks of the decoded document 730 are decoded by such overlaying in the following way. If either or both of a pixel of the first section 710 and its corresponding pixel of the second section 720 is black, then the corresponding pixel of the decoded document 730 is black. Only if both a pixel of the first section 710 and its corresponding pixel of the second section 720 is white, is the corresponding pixel of the decoded document 730 also white.

The decoded document 730 has pixel blocks organized along rows 732A, 732B, 732C, 732D, and 732E, and columns 734A, 734B, 734C, 734D, and 734E. Each pixel block of the decoded document 730 can be referenced as (p, q), where p is the reference number of the column in which the pixel block lies, and q is the reference number of the row in which the pixel block lies. Each pixel block of the decoded document 730 corresponds to a pixel block of the second section 720, to a pixel block of the first section 710, and to a pixel of the document 700. For example, the pixel block (734A, 732A) of the decoded document 730 corresponds to the pixel block (724A, 722A) of the second section 720, to the pixel block (714A, 712A) of the first section 710, and to the pixel (704A, 702A) of the document 700.

As an example of how the decoded document 730 is generated, the pixel bock (734A, 732A) of the decoded document 730 is generated by overlaying the pixel block (714A, 712A) of the first section 710 over or under the pixel block (724A, 722A) of the second section 720. Both the pixel block (714A, 712A) of the first section 710 and the pixel block (724A, 722A) of the second section 720 are the pixel block 300 of FIG. 2A. Therefore, the decoding process occurs as depicted in FIG. 3A, and the pixel block (734A, 732A) of the decoded document 730 is also the pixel block 300 of FIG. 2A. That is, the upper left-hand pixel and the lower right-hand pixel of each of the pixel block (714A, 712A) of the first section 710 and of the pixel block (724A, 722A) of the second section 720 are black, resulting in the upper left-hand pixel and the lower right-hand pixel of the pixel block (734A, 732A) of the decoded document 730 being black. Similarly, the upper right-hand pixel and the lower left-hand pixel of each of the pixel block (714A, 712A) of the first section 710 and of the pixel block (724A, 722A) of the second section 720 are white, resulting in the upper right-hand pixel and the lower left-hand pixel of the pixel block (734A, 732A of the decoded document 730 being white.

As another example, the pixel block (734C, 732C) of the decoded document 730 is generated by overlaying the pixel block (714C, 712C) of the first section 710 over or under the pixel block (724C, 722C) of the second section 720. The pixel block (714C, 712C) of the first section 710 is the pixel block 350 of FIG. 2B, whereas the pixel block (724C, 722C) of the second section 720 is the pixel block 300 of FIG. 2A. Therefore, the decoding process occurs as depicted in FIG. 4, and the pixel block (734C, 732C) of the decoded document 730 is made up of entirely black pixels. The upper left-hand pixel of one of the pixel block (714C, 712C) of the first section 710 and of the pixel block (724C, 722C) of the second section 720 is black, so the resulting upper left-hand pixel of the pixel block (734C, 732C) of the decoded document 730 is black.

Similarly, the upper right-hand pixel of one of the pixel block (714C, 712C) of the first section 710 and of the pixel block (724C, 722C) of the second section 720 is black, so the resulting upper right-hand pixel of the pixel block (734C, 732C) of the decoded document 730 is black. Because the lower left-hand pixel of one of the pixel block (714C, 712C) of the first section 710 and of the pixel block (724C, 722C) of the second section 720 is black, the resulting lower left-hand pixel of the pixel block (734C, 732C) of the decoded document 730 is black. Finally, because the lower right-hand pixel of one of the pixel block (714C, 712C) of the first section 710 and of the pixel block (724C, 722C) of the second 720 is black, the resulting lower right-hand pixel of the pixel block (734C, 732C) of the decoded document 730 is black.

It can be said that the decoded document 730 represents the document 700 against the background of the first section 710. This is because for each pixel of the document 700 that is black, the corresponding pixel block of the decoded document 730 is made up of all black pixels. For example, the pixel (704D, 702B) of the document 700 is black, such that the pixel block (734D, 732B) is made up of all black pixels. However, for each pixel of the document 700 that is white, the corresponding pixel block of the decoded document 730 is identical to the corresponding pixel block of the first section 710. For example, the pixel (704E, 702E) of the document 7000 is white. As a result, the pixel block (734E, 732E) of the decoded document 730 is identical to the pixel block (714E, 712E) of the first section 710. That is, both the pixel block (734E, 732E) of the decoded document 730 and the pixel block (714E, 712E) of the first section 710 are the pixel block 350 of FIG. 2B.

In sum, the document 730 is a decoded representation of the document 700. Each black pixel block of the decoded document 730 corresponds to a black pixel of the document 700. Thus, the decoded document 730 is a larger but accurate representation of the document 700. Although white pixels of the document 700 are not rendered as completely white pixel blocks in the decoded document 730, neither are they rendered as completely black pixel blocks in the decoded document 730. Therefore, the document 700 is discernible within the decoded document 730. That is, the capital letter T of the document 700, as rendered using the five pixels (704B, 702B), (704C, 702B), (704D, 702B), (704C, 702C), and (704C, 702D) in FIG. 7A, is discernible within the decoded document-730, as rendered using five pixel blocks (734B, 732B), (734C, 732B), (734D, 732B), (734C, 732C), and (734C, 732D) in FIG. 7D.

The term overlaying reflects the decoding process performed between the first section 710 and the second section 720 to yield the decoded document 730. For instance, the first section 710 could be output on a first transparency sheet, and the second section 720 could be output on a second transparency sheet. Overlaying the first transparency sheet over or under the second transparency sheet, such that the pixel blocks of the first section 710 are aligned over or under their corresponding pixel blocks of the second section 720, would then yield the decoded document 730. Where one of the corresponding pixels of the transparency sheets is black, a black pixel would be revealed when the first transparency sheet is overlaid under or over the second transparency sheet. Only where corresponding pixels of both transparency sheets are white would overlaying the first transparency sheet under or over the second transparency sheet yield a white pixel.

Furthermore, as described in more detail earlier in the detailed description, the term overlaying as used herein can be performed electronically. That is, the overlaying of corresponding pixel blocks of the two sections to yield the decoded document can be performed by or at a computerized device. In such an instance, the background of the first section against which the decoded document is instantiated may be automatically cleared, to improve the viewer's discerning of the decoded document, as has also been explained in more detail earlier in the detailed description.

Conclusion

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
generating a first plurality of blocks of pixels corresponding to pixels of a document; and,
generating a second plurality of blocks of pixels by transforming the first plurality of blocks of pixels, based on values of the pixels of the document to which the first plurality of blocks correspond.

2. The method of claim 1, further comprising outputting the first plurality of blocks of pixels and the second plurality of blocks of pixels.

3. The method of claim 2, wherein outputting the first plurality of blocks of pixels and the second plurality of blocks of pixels comprises printing each of the first plurality of blocks of pixels and the second plurality of blocks of pixels on a separate sheet of media.

4. The method of claim 2, wherein outputting the first plurality of blocks of pixels and the second plurality of blocks of pixels comprises outputting a first data file for the first plurality of blocks of pixels and a second data file for the second plurality of blocks of pixels.

5. The method of claim 1, wherein generating the first plurality of blocks of pixels comprises at least substantially generating each pixel of each block as one of a plurality of values.

6. The method of claim 5, wherein generating the second plurality of blocks of pixels comprises generating the pixels of each block of the second plurality of blocks of pixels by inverting the pixels of a corresponding block of the first plurality of blocks of pixels where the value of a corresponding pixel of the document is a predetermined value.

7. The method of claim 1, wherein generating the first plurality of blocks of pixels comprises at least substantially generating each block as one of a plurality of predetermined different blocks of pixels.

8. The method of claim 7, wherein generating the second plurality of blocks of pixels comprises generating the pixels of each block of the second plurality of blocks of pixels by inverting the pixels of a corresponding block of the first plurality of blocks of pixels where the value of a corresponding pixel of the document is a predetermined value.

9. The method of claim 1, wherein each of the first plurality of blocks of pixels and the second plurality of blocks of pixels comprises a plurality of square blocks of pixels.

10. The method of claim 9, wherein the plurality of square blocks comprises a plurality of two pixel-by-two pixel square blocks.

11. The method of claim 1, wherein the value of each pixel of the document is selected from a first value and a second value.

12. A method comprising:
receiving a first section having a number of first blocks of pixels representing an encoding and decoding section and a second section having a number of second blocks of pixels representing an encoded document; and,
overlaying the second section relative to the first section to decode the document.

13. The method of claim 12, wherein receiving the first section and the second section comprises receiving the first section and the second section on a first sheet of media and a second sheet of media, respectively.

14. The method of claim 13, wherein overlaying the second section relative to the first section comprises aligning one of the first and the second sheets of media over another of the first and the second sheets of media.

15. The method of claim 13, wherein overlaying the second section relative to the first section comprises scanning in the first and the second sheets of media to yield a first image file and a second image file, respectively.

16. The method of claim 12, wherein receiving the first section and the second section comprises receiving the first section and the second section as a first data file and a second data file, respectively.

17. The method of claim 16, wherein overlaying the second section relative to the first section comprises displaying one of the first and the second data files over another of the first and the second data files.

18. A computer-readable medium having a computer program stored thereon to perform a method comprising:
generating a number of first blocks of pixels; and,
generating a number of second blocks of pixels by selectively inverting the number of first square blocks, based on values of pixels of a corresponding document.

19. The medium of claim 18, wherein generating the number of first blocks comprises generating each pixel of each first block as one of an on pixel and an off pixel.

20. The medium of claim 19, wherein generating the number of second blocks comprises, for each pixel of the document,
where the pixel of the document is one of an on pixel and an off pixel, inverting the pixels of a corresponding first block to generate the corresponding second block; and,
where the pixel of the document is another of the on pixel and the off pixel, copying the pixels of the corresponding first block to generate the corresponding second block.

21. The medium of claim 18, wherein the computer program is executable by a computing device.

22. The medium of claim 18, wherein the computer program is executable by an image-forming device.

23. A computer-readable medium having a computer program stored thereon to perform a method comprising:
receiving a first data file having a number of first blocks of pixels and a second data file having a number of second blocks of pixels that encode a document by selective inversion of the number of first blocks based on corresponding values of pixels of the document; and,
displaying one file of the first and the second data files over another file of the first and the second data files to decode the document.

24. The medium of claim 23, wherein receiving the first and the second data files comprises receiving the first and the data files sections as a scanned-in first image file and a scanned-in second image file, respectively.

25. The medium of claim 23, wherein displaying the one file over the other file comprises performing an exclusive-or operation of each of the first blocks of pixels relative to a corresponding one of the second blocks of pixels.

26. The medium of claim 23, wherein displaying the one file over the other file comprises, for each of the first blocks of pixels,
where a corresponding one of the second blocks of pixels is identical to the first block of pixels, displaying one of a block of one or more on pixels and a square block of one or more off pixels; and,
where the corresponding one of the second blocks of pixels is inverted relative to the first block of pixels, displaying another of the block of one or more on pixels and the block of one or more off pixels.

27. The medium of claim 23, wherein the computer program is executable by a computing device.

28. An image-forming device comprising:
an image-forming mechanism; and,
a controller to cause the image-forming mechanism to output a first sheet of media having a number of blocks of pixels and a second sheet of media having a number of blocks of pixels corresponding to a selective inversion of the number of blocks based on values of the pixels of a document.

29. The image-forming device of claim 28, wherein the image-forming mechanism is one of a laser-printing mechanism and an inkjet-printing mechanism.

30. An article of manufacture comprising:
a medium; and,
a plurality of blocks of pixels on the medium that encodes a document by selective inversion of a plurality of other blocks of pixels based on corresponding values of pixels of the documents.

31. The article of claim 30, wherein the medium comprises an medium on which an image-forming device can form an image, and the plurality of blocks of pixels on the medium comprises the image on the medium.

32. The article of claim 30, wherein the medium comprises a data storage medium on which a data file can be stored, and the plurality of blocks of pixels comprises the data file stored on the medium.

33. An article of manufacture comprising: a first section having a first plurality of blocks of pixels corresponding to pixels of a document; and,
a second section having a second plurality of blocks of pixels in which the first plurality of blocks of pixels have been transformed based on values of the pixels of the document to which the first plurality of blocks correspond.

34. The article of claim 33, wherein each of the first section and the second section is a separate sheet of media.

35. The article of claim 33, wherein each of the first section and the second section is an electronic data file.
